(19) United States
(12) Patent Application Publication
(10) Pub. No.: US 2012/0073183 A1
(43) Pub. Date: Mar. 29, 2012

(54) Adaptable Fishing Float

(76) Inventor: Stephen Randolph Kissee, Slinell, LA (US)

(21) Appl. No.: 12/891,134

(22) Filed: Sep. 27, 2010

(51) Int. Cl. A01K 93/00; A01K 93/02

(52) U.S. Cl. 43/43.14; 43/44.9

(57) ABSTRACT

An adaptable fishing float with customizable rattle and weight content. The device itself is comprised of an upper and lower member made with buoyant material. Inside the upper member is housed a threaded cap with a watertight seal. Inside the lower member is housed a hollow plastic cylinder with a threaded upper rim for use in attaching to the threaded cap of the upper member. When the two members are attached, they form a cone shape with a width of two and one eight inches at the top and tapering down to one inch at the bottom. The cylinder inside the float can house a variety of steel, plastic, and glass beads to produce a fish attracting rattle sound. The cylinder can also house steel and lead weights to improve casting distances and float stability. A variety of other fish attractants can be housed within the cylinder. Such a device can be employed as a conventional fishing float used for rod and reel casting. The device is particularly useful in that both the amount of weight and rattle can be adjusted to suit the constantly changing fishing environments throughout a given day eliminating the need to search for and change to the proper float, all the while having to cut line and untie/tie knots. In addition, due to the unique method in which the fishing line is attached to the upper and lower member by use of small eyelets, float tangles are almost completely eliminated, even when casting into the wind.

### BACKGROUND OF THE INVENTION

1. Field of the Invention

The present invention relates to fishing floats, but more so to an adaptable fishing float that is comprised of two members that can be screwed together while housing a watertight plastic cylinder inside. When the two members are joined together, a cone shaped fishing float is obtained. Inside the watertight cylinder can be housed rattling devices such as steel, glass, or plastic beads. Also, lead or steel weights can be added to enhance casting distances. The containment options are limitless.

2. Description of Prior Art

The use of fishing floats is well known. Usually the fisherman rigs a fishing line with a variety of hooks and sinkers. A fishing float is positioned above the hook and sinker apparatus.

There are various types of floats currently available which may provide different amounts of weight and/or rattling sounds. The type of float configuration selected depends heavily on the fishing conditions and fish preferences on any given day. Fishing float configuration needs can and do change throughout the day. At times more rattle is needed. Other times, if the wind picks up, more weight may be needed.

Commonly, a fishing float is designed to satisfy a particular set of conditions, i.e. it is of fixed weight and fixed rattle. This creates an annoying problem of having to find the “right” float for the current conditions. Changing out a fishing float can be a very time consuming job especially when needing to be performed several times in a day. This could involve cutting of line and/or untying/tying knots.

The need to own all of the various fishing floats containing the desired rattle and weight combinations can be quite an expensive proposition.

There is a need for a single fishing float that can adapt to the ever changing fishing environments during the course of the day. An adaptable fishing float with infinite rattle and weight combinations solves the above mentioned problems.

The prior art of the fishing line float does not provide for a removable float that has the ability to house different types of media simultaneously and fully adjustable by the user even while the float is attached to fishing line.

Different types of rattle bead and/or weight bead combinations can be deployed allowing the fisherman to adjust both the buoyancy and noise level of the float by utilizing the dual chambers inside of the float. This ability to change both the weight and noise level provides the fisherman with a distinct advantage to catch more fish without the hassle of constantly having to switch floats based on the fishing conditions at hand.

The floats of U.S. Pat. Nos. 2,784,518, 2,811,805, 3,736,690, 4,696,125, 6,510,646, 6,510,646 , and Japan Pat Nos. JP 09009836 and JP 2004222523 do not allow the float to be filled with media contents as they operate as a closed and sealed unit.

The floats of U.S. Pat. Nos. 2,784,518, 3,736,690, and 6,173,524 describe different types of floats that are not readily removable as they all employ a fishing line that runs through the body of the float.

The float of U.S. Pat. No. 4,696,125 describes a different type of float in that it employs a water valve to maintain buoyancy and does not allow the addition of rattle beads.

### BRIEF SUMMARY OF THE INVENTION

In view of the aforementioned, the object of the present invention is to provide an adaptable fishing float.

Another object of the present invention is an infinitely adjustable fishing float to obtain the correct amount of rattle and weight desired. This objective is achieved by simply un-screwing the upper member from the lower member and either adding or removing rattle beads and/or weights.

A further object of the present invention is the ease in which the float can be attached and removed without having to cut fishing line or untie knots. The float can also be positioned higher or lower on the line by simply sliding it.

These and other features of the present invention will be better understood after review of the detailed description and drawings.

### BRIEF DESCRIPTION OF THE DRAWINGS

FIG. 1 View of present invention as seen from the top of upper member, eye hook not shown

FIG. 1a View of present invention as seen from the bottom of upper member, hollowed chamber, cap inserted

FIG. 2 View of the present invention as seen from the side

FIG. 3 View of the present invention as seen from the side when top and bottom members are separated

FIG. 4 View of present invention as seen from the top of lower member

FIG. 4a View of present invention as seen from the bottom of lower member, eye hook not shown

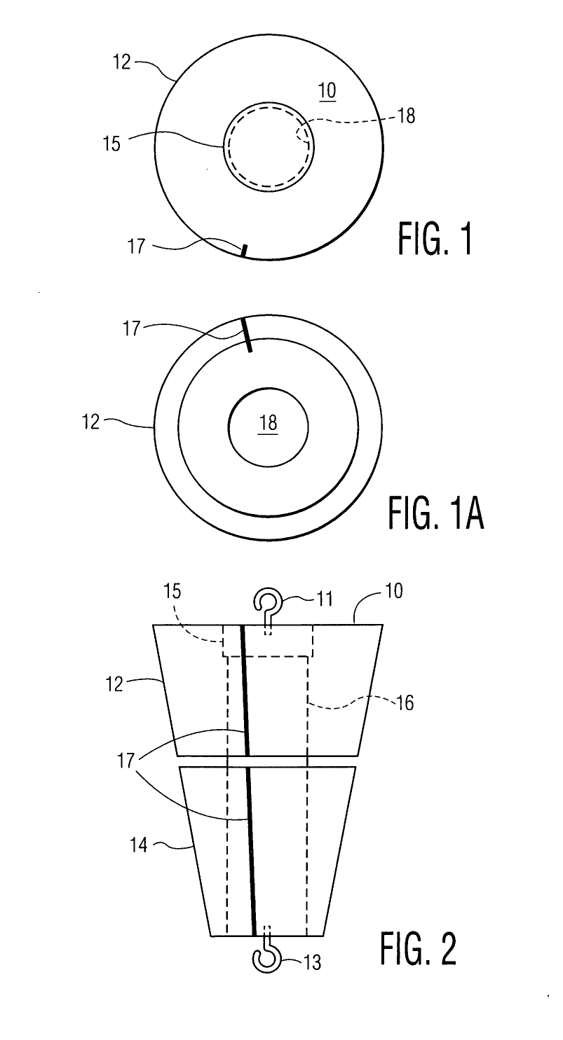

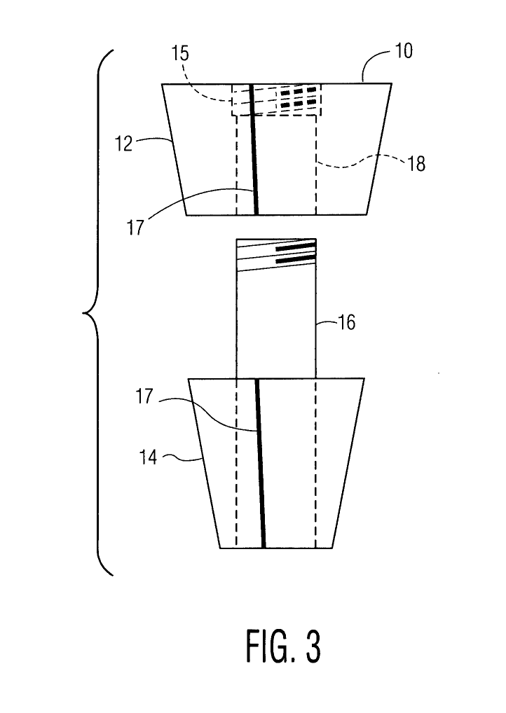

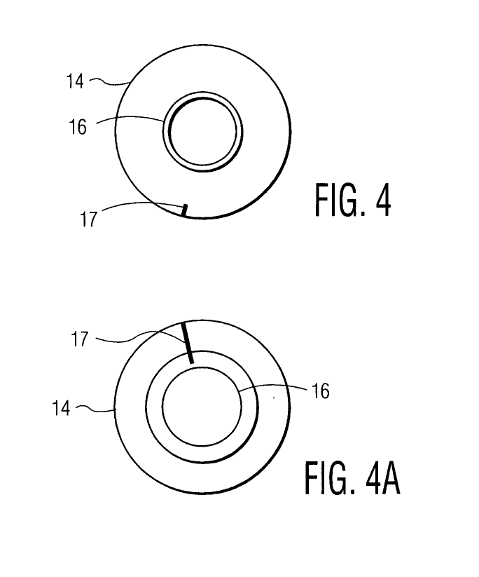

1.) An adaptable fishing float comprised of an upper and lower member, both of which are made of a buoyant material. Inside the upper member, flush with the very top, is mounted a threaded cap with a watertight seal. Inside the lower member is mounted a hollow plastic cylinder with a threaded rim at the top. The lower member is attached to the upper member by screwing the hollow plastic cylinder of the lower member into the threaded cap of the upper member and creating a fishing float with a watertight hollow plastic cylinder inside.

2.) An adaptable fishing float, as claimed in 1, including an aperture mounted in the center at the top of the upper member and in the center at the bottom of the lower member for receiving a fishing line. The small size of the apertures allow for tangle free operation.

3.) An adaptable fishing float, as claimed in 1 & 2, with a channel or slit running from the top of the upper member to the bottom of the lower member to house and conceal the fishing line after being attached to the upper and lower apertures.

4.) An adaptable fishing float, as claimed in 1, 2, & 3, containing a watertight hollow plastic cylinder which can adapt to changing fishing conditions by housing a variety of component contents such as steel, plastic, and/or glass beads for producing a fish attracting rattling sound, or additional steel or lead weights for distance casting and float stability.

5.) An adaptable fishing float, as claimed is 1, 2, 3, & 4, containing fish attracting oils in which case the aperture at the bottom of the float is slightly loosened to allow for the release of the oils.

6.) An adaptable fishing float, as claimed in 1, 2, 3, 4, & 5, wherein said device is buoyant.

7.) An adaptable fishing float, as claimed in 1, 2, 3, 4, 5, & 6, wherein said device produces a bait-like splash action on the water surface when the fishing line is jerked due to the large flat design of the surface area at the top of the upper member.
